(19) United States
(12) Patent Application Publication
(10) Pub. No.: US 2026/0111189 A1
(43) Pub. Date: Apr. 23, 2026

(54) Method and Device for Code Generation for a Program Code for Calculating an Artificial Neural Network in a Hardware Environment

(71) Applicant: Robert Bosch GmbH, Stuttgart (DE)

(72) Inventors: Benjamin Wagner, Friedrichshafen (DE); Duy Khoi Vo, Waiblingen (DE); Leif Sulaiman, Lund (SE); Markus Lochmann, Reutlingen (DE); Sebastian Boblest, Duernau (DE); Ulrik Hjort, Malmö (SE)

(21) Appl. No.: 19/359,926

(22) Filed: Oct. 16, 2025

(30) Foreign Application Priority Data
Oct. 18, 2024 (EP) 24207521.6

(51) Int. Cl. G06F 8/35; G06N 3/048

(52) U.S. Cl. CPC G06F 8/35; G06N 3/048

(57) ABSTRACT

A method is for performing memory planning for code generation to determine a code for calculating a neural network for use in a hardware environment. The method includes providing successive calculation steps of the neural network. A size of at least one input data block and at least one output data block is determined for each calculation step. The method further includes determining a maximum overlap area between an input data block and an output data block for each calculation step. The method includes performing memory planning in which the memory area of the respective input data block and output data block is determined in the working memory, depending on the maximum overlap area for each calculation step.

This application claims priority under 35 U.S.C. § 119 to patent application no. EP 24207521.6, filed on Oct. 18, 2024 in Europe, the disclosure of which is incorporated herein by reference in its entirety.

The disclosure relates to the implementation of a program code on a hardware environment, such as that occurring as microcontroller-controlled control devices and the like. The disclosure further relates to methods for memory planning for handling input data, output data and network parameters.

### BACKGROUND

Certain hardware environments, such as microcontrollers in control devices, require the creation of an adjusted executable program code to take into account the characteristics and limitations of the specific hardware environment. In particular, the available memory size of the working memory that the microcontroller may directly access may be limited, or memory shifting or copy operations from a flash or external memory to the working memory may be particularly complex due to hardware constraints.

The calculation steps for calculating layers of neural networks can require considerable memory, since for each calculation step at least one input data block and at least one output data block must be retrieved and stored in the working memory in a form that can be used by the microcontroller.

During memory planning, existing code generators determine in which area of the working memory the data blocks required per calculation layer are stored in memory. During memory planning, in addition to mapping the input data blocks and output data blocks to memory areas, a corresponding memory area is also assigned to the data that arises during the calculation in a calculation layer.

Conventional code generators for neural networks often do not assume limited data memory and typically use separate memory blocks for providing input data blocks and output data blocks for each of the successive calculated calculation layers.

It is the object of the disclosure to provide improved memory management for calculating artificial neural networks in which the total memory space required can be reduced.

### SUMMARY

This task is solved by the method for performing memory planning for code generation of a code for calculating a neural network as well as by the device disclosed herein.

Further embodiments are specified in the dependent claims.

According to a first aspect, a computer-implemented method for performing memory planning for a code generation for determining a code for computing a neural network is provided, with the steps of (i) providing successive calculation steps of the neural network, wherein the size of one or more input data blocks and one or more output data blocks is determined for each calculation step, (ii) determining a maximum overlap area between each input data block and each output data block for each calculation step, (iii) performing memory planning in which the memory area of the respective input data block and output data block is determined in the working memory, depending on the maximum overlap area for each calculation step.

The individual calculation steps for calculating calculation layers of a neural network are typically calculated serially on a hardware environment. This means that the generated code specifies an order for the hardware environment in which the input data is processed and the output data of the respective calculation layer is generated. The input data for a calculation step is generally in the form of successively stored data elements (bytes, words). Furthermore, as a result of serial processing, input data is processed in the order in which it is stored in a memory area. This can lead to a situation where, depending on the type of calculation step used to calculate a corresponding calculation layer of the neural network, the data elements of the input data used at the start of the calculation are not used or accessed again in the further course of the calculation. For example, this occurs in calculation steps, such as the calculation of a convolution layer, depthwise convolutions, pooling operations, and calculation steps with operations executed element-by-element.

The above method provides for memory planning of code generation providing an input data block and an output data block in overlapping memory areas such that during in a successive element-by-element processing of the input data, the data block of the respective generated data elements of the output data covers a portion of the memory area of the input data block.

However, overwriting is only carried out in such a way that no data elements still used for the calculation operations of the respective calculation step are overwritten, but only those that have already been used for the calculation of the operation and the calculation step and are no longer used. As a result, the memory requirement for a calculation step for calculating a calculation layer of a neural network that provides for processing of input data element-by-element can be significantly reduced.

To what extent the input data block of the input data and the output data block of the output data can overlap depends on the memory access pattern of the calculation step. For example, in a convolution calculation step where a convolution layer is calculated, the size of the effective kernel, as well as any buffer memory present, determine the degree of the overlap of the input data block and the output data block.

The size of the effective core is determined by the actual core size and any dilation. Other calculation steps may immediately completely overwrite the input data block, e.g. in a calculation step, for example, which provides an addition of two or more input data blocks element-by-element.

The advantage of the above method is that the amount of memory space required to calculate a neural network can decrease tremendously.

The memory planning calculation begins with a list of memory data blocks to be buffered into a corresponding memory area of the working memory, depending on upcoming calculation steps. Each of these memory data blocks is assigned a list of attributes, which, for example, specify the service life of the memory data block and which operation it is associated with.

For code generation, memory planning determines, by iteration through the calculation steps, in which memory area a memory data block for the input data and output data should be stored for each calculation step. It is conventionally noted that all memory areas for the data blocks must be distinct so that no overlap between the memory areas occurs during their service lives.

The size of the possible overlap between the memory area for the input data block and the memory area for the output data block is termed the overlap area and depends on the type of calculation step or layer of the neural network to be calculated. Depending on the calculation step, different ways of determining the overlap of the memory areas may be used.

The overlap area corresponds to the area where one end (largest address) of the storage area of the output data block may overlap the beginning (smallest address) of the memory area of the input data block. It is assumed that the memory areas are essentially read or written with essentially ascending addresses from a start address of the memory area to an end address as the end address of the memory area.

For element-by-element operations, such as additions, multiplications, and subtractions of elements having the same index from two input data blocks, a complete overlap of the memory area for the output data block with the memory area of one of the input data blocks may be provided because the result of the linking may overwrite the input data element used for the calculated operation.

Similar to element-by-element operations, a computation step for applying an activation function, such as ReLU (not for SoftMax), a data element of the output data block for each data element of an input data block. As with the element-by-element calculation step, the memory area allocated for the output data block can thus completely overlap the memory area for the input data block.

Calculation steps for a convolution layer or pooling layer have a more complex memory access pattern. On the one hand, a data element of the output data block is calculated from several data elements of the input data block; on the other hand, padding and stride complicate the relationship between the memory area of the input data block and the memory area of the output data block. In addition, the amount of maximum overlap in these cases depends on the specific implementation of the network layer and can therefore only be derived if known. Both types of calculation steps, convolution and pooling, calculate the respective data element for the output data block from a sliding window that moves over the input data block. Decisive for the size of the maximum overlap of the memory areas is the maximum distance between the data element of the output data block and the first required data element of the input data block.

The related calculation rule is generally based on the memory being organized into rows and columns and a memory area having a contiguous address range of successive addresses. Generally, a memory area of an input data block is processed from the lowest-value address to the most-value address of the memory area. Let x and y be the address coordinates of the data element of the input data block, wherein X corresponds to the column address and y to the row address. strideₓ and stride_{y} continue to be assumed to be the stride of the operation in the x and y directions, padₓ and pad_{y} correspond to the padding of the operation in the x and y directions, ReLU is the rectified-linear unit function, and inputₓ, input_{y} and input_{ch} are the width, height and number of channels of the input data. Then, for all convolution and pooling type operations having the access pattern described above, the index of the first data element required in memory may be calculated according to the following formula:

$$input\_element ( x , y ) = ( ReLU ( {stride}_{y} * y - {pad}_{y} ) * {input}_{x} + ReLU ( {stride}_{x} * x - {pad}_{x} ) ) * {input}_{ch}$$

If the outputₓ, output_{y} and output_{ch} are used to denote the width, height and number of channels of the output data, the index of the output element in memory results in

$$output\_element ( x , y ) = ( y * {output}_{x} + x ) * {output}_{ch} .$$

In order to calculate the largest possible overlap from these formulas, additional information about the specific implementation of the calculation steps is required.

In many implementations, the input data needed to calculate an output element is first collected in a contiguous memory area. As they have then already been read, they can be overwritten if they no longer require a later output element. As an additional optimization step, data is often collected in advance not only for one output element, but for a specific, implementation-dependent number of output elements. This increases the maximum possible overlap.

Without pre-collecting data, the largest possible overlap is calculated as

$$max\_overlap = max ( output\_element ( x , y ) - input\_element ( x , y ) )$$

$$with 0 \leq x < {output}_{x} , 0 \leq y < {output}_{y}$$

With pre-collection, it increases accordingly by the corresponding number of temporarily stored elements.

The maximum overlap max_overlap now specifies the maximum offset by which the end of the memory area of the output data block may overlap the beginning of the memory area (highest address) of the input data block. The determination of the maximum overlap is determined from the maximum of all distances between the memory address of the resulting data element of the output data block relative to the data element of the input data block (smallest address) first accessed for the respective calculation for all data elements.

Determining the maximum overlap max_overlap allows for greater freedom in placing the memory area for the output data block when planning memory for code generation.

### BRIEF DESCRIPTION OF THE DRAWINGS

Preferred embodiments are described in more detail below with reference to the accompanying drawings. The figures show:

FIG. 1 a schematic representation of a memory plan for calculating a neural network in a plurality of calculation steps without overlapping memory areas;

FIG. 2 a schematic illustration of a platform for code generation and implementation in a hardware environment;

FIG. 3 a flow chart illustrating a method of memory planning as part of code generation for computing a neural network in a hardware environment with limited memory space; and

FIG. 4 a corresponding representation of the arrangement of memory areas for input data blocks, with the possibility that that memory areas for the data blocks may overlap.

### DETAILED DESCRIPTION

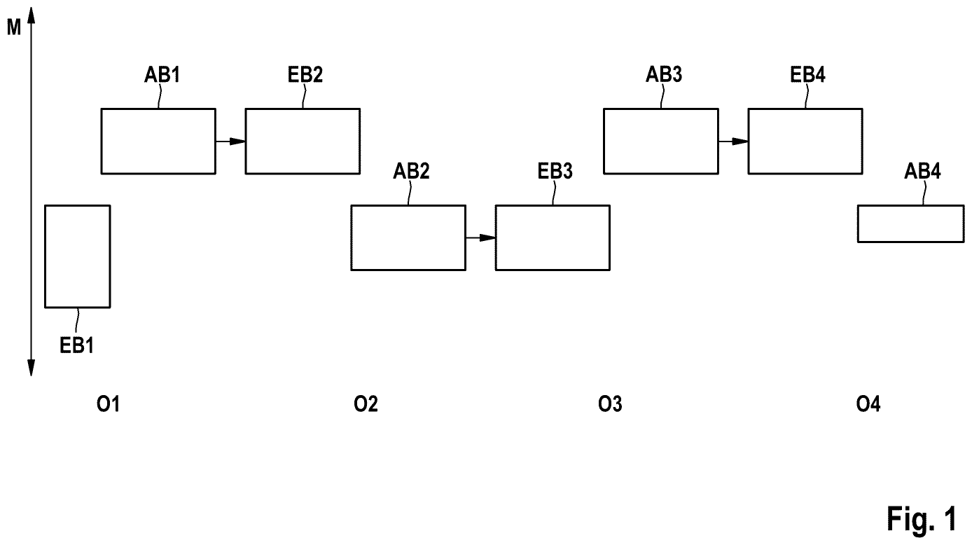

Code generation requires memory planning that specifies a memory area for one or more input data blocks and a memory area for one or more output data blocks for their respective lifetimes for each calculation step of a neural network. Conventionally, memory planning is carried out which only provides for a memory area to be released for an input data block and an output data block when their lifetime has expired. The service life is always specified up to the end of the calculation step or the subsequent calculation steps. The placement of the memory sections in conventional memory planning is shown schematically in FIG. 1. Input data blocks EB1, EB2, EB3, EB4 for different calculation steps O1, O2, O3, O4 and the resulting output data blocks AB1, AB2, AB3, AB4 can been seen.

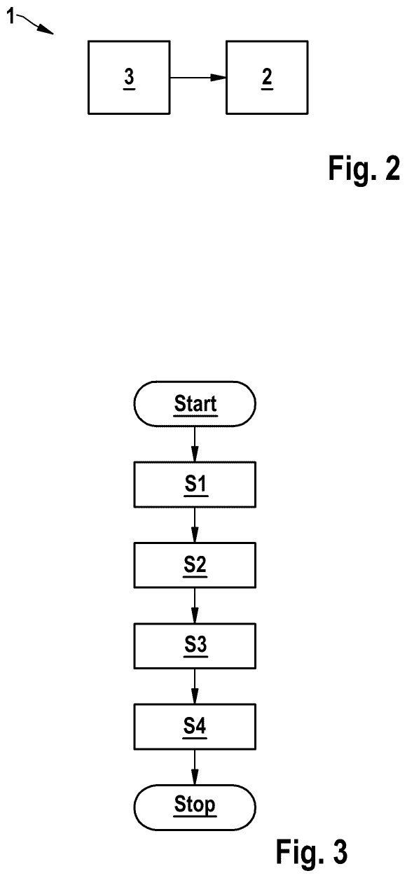

FIG. 2 shows a block diagram of a platform 1 for performing code generation and implementing a generated program code in a hardware environment 2. Code generation is done on a conventional computer 3 or workstation based on the specified configuration of a neural network. Computer 3 is configured to perform memory planning and code generation, wherein memory planning first performs placement of memory spaces for the individual calculation steps of the neural network to accommodate at least one input data block, one output data block, and at least one model parameter block. The model parameter block comprises all model parameters needed for the calculation of the respective calculation step, e.g. weightings, bias values of a fully connected layer.

Once the code has been generated, it is transferred to the hardware environment 2, where it is implemented or executed.

As part of the method described below, it may now be provided that the memory area for an output data block of a calculation step is provided at least partially overlapping with the memory area of an input data block for the calculation step. This can significantly conserve memory space because the memory areas for the input data block and the output data block need not be provided completely non-overlapping.

Memory planning is usually carried out iteratively in the form of an optimization process and may aim to reduce the total memory space, minimize copy and move operations of memory areas, and so on.

The method described below in connection with the flowchart in FIG. 3 makes it possible to provide overlapping areas between the memory area for the input data block and the output data block for certain types of calculation steps, thereby increasing the degrees of freedom in memory planning. For this purpose, a maximum overlap area is specified for each calculation step.

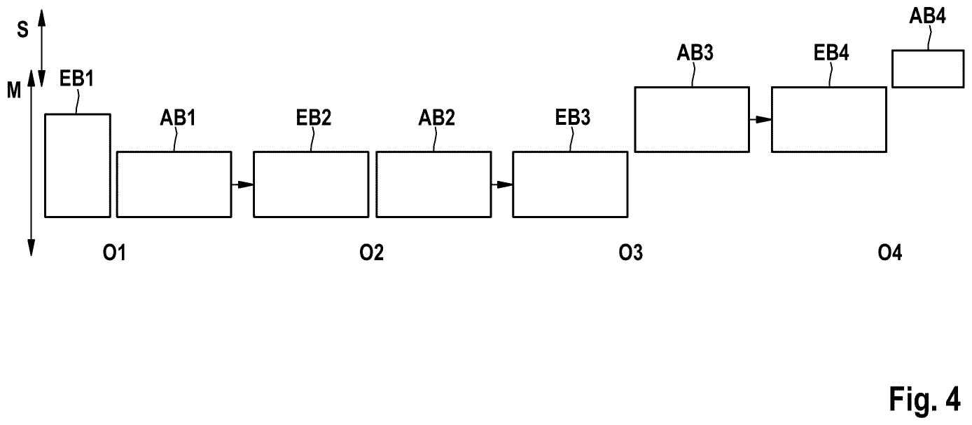

FIG. 4 shows, for example, how the memory areas for the input data blocks EB1, EB2, EB3, EB4 and output data blocks AB1, AB2, AB3, AB4 can be arranged for the multiple calculation steps of a neural network shown in FIG. 1, if these are allowed to overlap at least partially. It can be seen that there is significantly less memory requirement for working memory M and that the total memory space of the total required working memory M can be reduced by a saved portion S.

FIG. 3 shows the sequence of the method for memory planning using a flow chart. For memory planning, it is generally intended to define, for each calculation step, either the input data block that is initially loaded into the memory space of the working memory M, or the memory area that results from a previous calculation step as the output data block, in which memory area of the working memory a resulting output data block AB1, AB2, AB3, AB4 may/should be stored. In order to do so, it is necessary to define or determine the maximum overlap area in addition to the unused memory areas, with which a memory area of the output data block AB1, AB2, AB3, AB4 may at most overlap the memory area of the input data block EB1, EB2, EB3, EB4 used for the respective calculation step. This increases the available memory area that may be used for the storage of the respective output data block AB1, AB2, AB3, AB4.

In step S1, the neural network to be implemented is first provided in the form of a sequence of calculation steps. The calculation steps may generally include the functions common to neural networks, such as convolutional layer, fully connected layer, pooling layer, concatenation layer, and the like.

In step S2, it is determined for each calculation step how large the maximum overlap area between input data block EB1, EB2, EB3, EB4 and output data block AB1, AB2, AB3, AB4 may be.

If the calculation step is an element-by-element operation in which two or more sections of the input data block EB1, EB2, EB3, EB4 or two or more input data blocks EB1, EB2, EB3, EB4 are linked with each other element-by-element, the result of the element-by-element operation of the calculation step may be directly overwrite the memory space of the data element of one of the sections of the input data block EB1, EB2, EB3, EB4 or one of input data blocks EB1, EB2, EB3, EB4, as the corresponding data element is not used for subsequent operations. The maximum overlap area then corresponds to the size of the section of the input data block EB1, EB2, EB3, EB4, or one of the input data blocks EB1, EB2, EB3, EB4. Thus, the memory area of the output data block may completely overlap one of the sections of the input data block EB1, EB2, EB3, EB4 that are offset with each other.

If the calculation step is a convolution or pooling calculation step, then several elements of the input data block EB1, EB2, EB3, EB4 are processed into a data element of the output data block AB1, AB2, AB3, AB4. In this case, the size of the overlap region may be determined by calculating the maximum distance between the address of a data element of the output data block AB1, AB2, AB3, AB4 and the address of a data element of the multiple data elements first accessed for the single calculation, which is used for the single calculation in the calculation step. The related calculation rule is generally based on the memory being organized into rows and columns and a memory area having a contiguous address range of successive addresses.

Generally, a memory area of an input data block EB1, EB2, EB3, EB4 is processed from the lowest-value address to the most-value address of the memory area.

Let x and y be the address coordinates of the data element of the input data block EB1, EB2, EB3, EB4, wherein X corresponds to the column address and y to the row address. strideₓ and stride_{y} continue to be assumed to be the stride of the operation in the x and y directions, padₓ and pad_{y} correspond to the padding of the operation in the x and y directions, ReLU is the rectified-linear unit function, and inputₓ, input_{y} and _{inputch} are the width, height and number of channels of the input data. Then, for all convolution and pooling type operations having the access pattern described above, the index of the first data element required in memory may be calculated according to the following formula:

$$input\_element ( x , y ) = ( ReLU ( {stride}_{y} * y - {pad}_{y} ) * {input}_{x} + ReLU ( {stride}_{x} * x - {pad}_{x} ) ) * {input}_{ch}$$

If the outputₓ, output_{y} and output_{ch} are used to denote the width, height and number of channels of the output data, the address of the output element in memory results in

$$output\_element ( x , y ) = ( y * {output}_{x} + x ) * {output}_{ch} . \qquad ( 2 )$$

The largest possible overlap max_overlap is then calculated without re-collecting the input data as

$$max\_overlap = max ( output\_element ( x , y ) - input\_element ( x , y ) )$$

$$with 0 \leq x < {output}_{x} , 0 \leq y < {output}_{y}$$

With pre-collection, it increases accordingly by the corresponding number of temporarily stored elements.

This calculation is performed for each data element of the input data block and the maximum of the difference of the thus determined values is determined. The resulting value of the maximum corresponds to the size of the maximum overlap area max_overlap representing the storage area, at the beginning of the storage area of the input data block, with which the end of the output data block AB1, AB2, AB3, AB4 may overlap.

Once the maximum overlap area has been determined for each calculation step, memory planning is carried out in step S3, for example based on an optimization method that takes into account the total required size of the working memory as the objective function. In particular, the targeting function may specify that the overall amount of working memory required is minimized. The memory planning may be performed with an SMT solver in a manner known by itself.

In step S4, code generation for hardware environment 2 is performed and implemented based on the memory planning being performed.

What is claimed is:

1. A method of performing memory planning for code generation to determine a code for calculating a neural network for use in a hardware environment, the method comprising:
providing successive calculation steps of the neural network, and determining a size of at least one input data block and at least one output data block for each calculation step;
determining a maximum overlap area between the at least one input data block and the at least one output data block for each of the successive calculation steps; and
performing memory planning for the successive calculation steps in which a memory area of the at least one input data block and the at least one output data block is determined in a working memory, based on the maximum overlap area for each of the successive calculation steps.

2. The method according to claim 1, wherein performing the memory planning comprises applying an optimization method in which a target function is configured to minimize a total required amount of the working memory.

3. The method according to claim 1, wherein:
the at least one input data block and the at least one output data block each specify or are associated with the memory area having successively ascending addresses, and
the successive calculation steps access data elements of the at least one input data block in ascending addresses.

4. The method according to claim 1, wherein:
the maximum overlap area corresponds to an area with which an end of the memory area of the at least one output data block overlaps a start of a memory range of the at least one input data block, and
the memory area includes substantially ascending addresses that are read or written from beginning at a start address of the memory area and ending at an end address of the memory area.

5. The method according to claim 1, wherein the successive calculation steps providing individual element-by-element calculations are assigned a complete overlap of the memory area for the at least one output data block with the memory area of a section of the at least one input data block.

6. The method according to claim 1, wherein:
the successive calculation steps for a convolution layer or a pooling layer are associated with a maximum overlap max_overlap resulting from a calculation rule provided by:
$$input\_element ( x , y ) = ( ReLU ( {stride}_{y} * y - {pad}_{y} ) * {input}_{x} + ReLU ( {stride}_{x} * x - {pad}_{x} ) ) * {input}_{ch}$$
$$output\_element ( x , y ) = ( y * {output}_{x} + x ) ○ output\_ch$$
$$max\_overlap = max ( output\_element ( x , y ) - input\_element ( x , y ) )$$
$$with 0 \leq x < {output}_{x} , 0 \leq y < {output}_{y}$$
x and y correspond to address coordinates of a data element of the at least one input data block,
x corresponds to a column address and y corresponds to a row address,
strideₓ and stride_{y} correspond to strides of an individual calculation in x and y directions, padₓ and pad_{y} correspond to paddings of an operation in the x and y directions, ReLU corresponds to a rectified linear unit function,
inputₓ, input_{y} and input_{ch} correspond to a width, height and number of channels of input data of the at least one input data block, and
outputₓ, output_{y} and output_{ch} correspond to a width, height and number of channels of output data of the at least one output data block.

7. The method according to claim 1, wherein the code generation for the hardware environment is performed based on a result of the memory planning.

8. A device, comprising:
a data processing device configured to perform the method according to claim 1.

9. The method according to claim 1, wherein a computer program product comprises instructions which, when the computer program product is executed by at least one data processing device, cause the at least one data processing device to perform the method.

10. A non-transitory machine-readable storage medium comprising commands which, when executed by at least one data processing device, cause the at least one data processing device to perform the method according to claim 1.
